(19) United States
(12) Patent Application Publication
(10) Pub. No.: US 2013/0036026 A1
(43) Pub. Date: Feb. 7, 2013

(54) Method to regularize and to stimulate the solidary transport of passengers

(71) Applicant: Marcio Henrique Nigro, Sao Paulo (BR)

(72) Inventor: Marcio Henrique Nigro, Sao Paulo (BR)

(21) Appl. No.: 13/641,866

(22) PCT Filed: Jul. 14, 2010
(86) PCT No.: PCT/BR10/00236

§ 371 Date: Oct. 17, 2012

(30) Foreign Application Priority Data
Apr. 22, 2010 (BR) 018100013998

(51) Int. Cl. G06Q 30/00

(52) U.S. Cl. 705/26.41

(57) ABSTRACT

The present invention refers to a method to allow and to stimulate the solidary transport of passengers, in the common way called hitchhiking or carpool.

### FIELD OF THE INVENTION

The present invention refers to a method to allow and to stimulate the solidary transport of passengers, in the common way called hitchhiking or carpool.

### BACKGROUND OF THE INVENTION

Currently, the processes to give and to receive hitchhiking are informal and little stimulated. This is related to difficulties for the driver (supplier of the hitchhiking) and for the passenger (receiver of the hitchhiking). The driver, in general, has difficulty to receive far reward, due shame to charge, what also occurs with the passenger who could be embarrassed to offer to split the costs.

As a result, there are few initiatives of hitchhiking, mainly in countries with wide territorial extension, wherein the main transport medium is the terrestrial one. In addition, the great cities have increasing problems with pollution and traffic and, small ones have scarcity and/or low quality of public transport.

Currently, there is no available method to regularize and to stimulate the solidary transport of passengers, remaining only the free negotiation between the parties.

Thus, it remains the need of ways to regularize and to stimulate the solidary transport of passengers

Aiming to provide a process of exchange and reward in the field of the solidary transport, also known as hitchhiking, a method has been developed that consists of providing a monetary entity, which is used to price the kilometer (or miles) of each route in this modality.

This currency/coin, called “CARONETA”, may be acquired by the internet/web, in a website that serves as a stock market of hitchhikings, where there is free trading and taxation of pathways and the respective price in the currency to be used.

Therefore, there is a pre-arranged value for each trip. The currency is acquired in the website in which there is a balance transfer of the amount related to each event from the account of whom receives the hitchhiking to whom offers the hitchhiking. At any time the user can redeem their accumulated currencies in partner stores.

The present invention provides a new impulse to the solidary transport, along with the creation of validations of data at already existing databases to guarantee the security of the users, for example, insurance companies, Social Security Numbers (or similar National Id), id's Database, confirmations of personal credit, virtual relationship websites, and others, as auxiliary information to help who offers the hitchhiking to select the appropriate person and vice versa.

Moreover, through the historic generated for each user during the hitchhiking process, who provides the to offer the solidary transport, for he will receive prizes for the covered kilometer, valued through the currency.

Besides, who gives the hitchhiking will be able to vary partners or to give hitchhiking to more than one user simultaneously. The stock market of hitchhikings can be used as reference for consultations every time that a driver wants to program a solitary trip to the beach, the airport, other town etc. in the attempt to get some passenger to divide the expenses.

1-5. (canceled)

6. A method for regularizing and stimulating solidary transport of passengers the method comprising:
(a) providing a website capable of intermediating on-line payment transactions; the website providing a virtual monetary unit used in the on-line payments on the website; where a user converts local currency into the virtual monetary units;
(b) establishing a monetary value for each distance unit of a trip; generating and suggesting a pre-determined value for each specific trip;
(c) subscribing at least one commercial entity to the website, the commercial entity accepting the monetary unit as payment;
(d) subscribing at least one passenger and at least one driver to the website; the website validating and authenticating the information of the subscribed passenger and subscribed driver and creating a virtual account of the subscribed passenger and a virtual account of the subscribed driver for each specific trip; for the on-line payment transactions of the monetary unit;
(e) The subscribed passenger acquiring an amount of monetary units on-line on the website for the subscribed passenger virtual account;
(f) the subscribed passenger transferring an amount of monetary units on-line from the virtual account of the subscribed passenger to the virtual account of the subscribed driver, as an advanced payment for the specific trip;
(g) the subscribed driver transporting the subscribed passenger for the paid specific trip, and
(h) the subscribed driver redeeming the monetary unit for use in the at least one subscribed commercial entity.

7. The method according to claim 6, wherein in item (c) the subscribed commercial entity is any commercial entity that provides products or services using web commerce.

8. The method according to claim 6, wherein the validating and authenticating of the information of the subscribed passenger and subscribed driver on the website is done through suitable authentication information and suitable entities.

9. The method according to claim 6, wherein the subscribed driver is able to accept multiple subscribed passengers for one same trip.
